(19) United States
(12) Patent Application Publication
(10) Pub. No.: US 2005/0259686 A1
(43) Pub. Date: Nov. 24, 2005

(54) Initiation of communication

(76) Inventor: Michael Lewis, Marsta (SE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/120,747

(22) Filed: May 3, 2005

(30) Foreign Application Priority Data
May 7, 2004 (EP) EP 04 010 918.3

(51) Int. Cl. H04J 3/16

(52) U.S. Cl. 370/469

(57) ABSTRACT

The invention relates to a system and method of setting up a communications channel between a sending unit and a receiving unit in a packet based communications network. The method, when applied in the context of IEEE 802.11 WLAN, provides a means for including extra training information with the RTS (or POLL) frame, and a means for returning at least some of the channel estimation data with the CTS frame, while maintaining full backward-compatibility with legacy 802.11a/802.11g stations. This provides increased efficiency, since reservation of the medium can be done in parallel with at least some of the channel estimate acquisition.

### REFERENCE TO RELATED APPLICATIONS

This application claims the benefit of the priority date of European application EP 04 010 918.3, filed on May 7, 2004, the contents of which are herein incorporated by reference in their entirety.

### FIELD OF THE INVENTIN

The present invention relates to a method of setting up a communications channel between a sending unit and a receiving unit in a packet based communications network.

### BACKGROUND OF THE INVENTION

It is generally a known problem to perform a set up procedure when establishing a communications channel in a network environment without adding too much overhead information, by keeping the set up procedure as short as possible.

When it comes to wireless LAN systems it is an aim to generate a new standard with a measured throughput of greater than 100 Mbit/s. The dominant technology that promises to be able to deliver these increased speeds are so-called MIMO systems. The maximum theoretical throughput of such a system scales linearly with the number of antennae, which is the reason that the technology is of great interest for high throughput applications. An example of such a system is shown in FIG. 1, with a sending unit, a laptop, transmitting to a receiving unit, an access point, where each unit or device has three antennae.

The reason why these systems can offer improved throughput compared to single antenna systems, is that there is spatial redundancy: each piece of information transmitted from each transmitting antenna travels a different path to each receiving antenna, and experiences distortion with different characteristics and thus different channel transfer functions.

In the example of FIG. 1, there are three different channel transfer functions from each antenna to each receiver: the transfer function from transmitting antenna x to receiving antenna y is denoted by Hxy. Greater capacity is obtained by making use of the spatial redundancy of these independent or semi-independent channels, perhaps in conjunction with other coding techniques, to improve the chance of successfully decoding the transmitted data. The examples given in this description use three transmitting antennae. It is however obvious for the skilled man that any arbitrary number of transmitting antennae can be used.

There is a wide range of published techniques for encoding information over a MIMO channel set, e.g., linear beam forming with a Wiener filter receiver, space time block coding, etc. In virtually all of the techniques, it is necessary to obtain a reasonably accurate estimate of the channel transfer functions, or the channel estimates, at least at the receiving unit. However, in order to make the best use of the available channel capacity, it is also necessary for these channel estimates to be transferred to the sending unit by means of an initial exchange of transmissions prior to the main data transfer.

In this specific environment it is thus a problem to set up the communications channel with optimised channel transfer functions between sending and receiving unit since the time overhead involved in this exchange leads to a trade-off, since it works against any increase in the rate of transfer of subsequent data. In practice, this means that the subsequent amount of data transferred must be sufficiently large that the average data rate remains sufficiently high.

An important criterion of the high-throughput WLAN standardisation activity is that the new systems can interoperate with existing 802.11a and 802.11g OFDM WLAN systems. This means, primarily, that the legacy systems can interpret sufficient information from the transmission of the new system such that they do not interact in a negative manner, e.g., making sure that legacy systems remain silent during an ongoing transmission of the new system.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a communication system, comprising a first optimising unit, belonging to the PHY-layer of a sending or transmission unit. The optimising unit appends communication parameters pertaining to the sending unit to the initiating packet which are sent during some of the time period used for the decoding by the PHY layer or evaluation by the MAC-layer of the receiving unit.

A second optimising unit, belonging to the PHY-layer of the receiving unit, analyses the communication parameters of the sending unit and appends communication parameters pertaining to the receiving unit to the responding packet which are sent during some of the time period used for the decoding by the PHY layer or evaluation by the MAC-layer of the sending unit.

The first optimising unit analyses the communication parameters of the receiving unit and optimises the set-up of the sending unit PHY-layer according to the communication parameters of the receiving unit. Similarly, the second optimising unit optimises the set-up of the receiving unit PHY-layer according to the communication parameters of the sending unit.

If the communications channel set-up comprises sending and receiving of several packets between the sending and receiving unit, then the first and second optimising units are configured and employed to operate any time required by the MAC-layers of the respective sending and receiving units to evaluate and form the packets to send communications parameters, to evaluate communication parameters and to optimise the set-up of respective PHY-layer.

The sending and receiving units, in one example, may be units working in a manner compatible with the IEEE 802.11a or 802.11g WLAN standard. In such case it is proposed that the initiating packet is a RTS or Poll message, and that the responding packet is a CTS message.

In one embodiment the analysing of received communication parameters performed by the first and second optimising units is done at least during the SIFS between the RTS or Poll, the CTS and any following communication packet.

In another embodiment, if the sending and receiving units are MIMO transceivers, the added communication parameters pertaining to the sending unit includes an extra training sequence to enable channel estimation, and the added communication parameters pertaining to the receiving unit includes channel feedback data.

Such an extra training sequence may include, for example, protocol information such as information on the number of transmitting antennae and the transmission rate to be used, and such channel feedback information may include channel estimates made by the second optimising unit, such as an optimised channel transfer function.

In one embodiment a reserved bit in the RTS or Poll message is used to indicate the use of the present invention to units within the network that are compatible with the new technique, which bit is ignored by legacy units in the network functioning according to IEEE 802.11a or 802.11g.

One mechanism that can be used to accomplish the possibility for the legacy systems to interpret sufficient information from the transmission of the new system is the network allocation vector (NAV) defined in the 802.11 WLAN standard, which is a timer that specifies a duration during which a transmitter must remain silent. Each transmission contains a “duration” field, and stations that receive a transmission not directed to them examine the duration field, and set their NAV accordingly. Thus, it is possible to “reserve the medium” through the exchange of a pair of short frames, where the duration field in each of the short frames is set such that it extends just beyond all subsequent transmissions. One such frame exchange uses a request to send (RTS) and clear to send (CTS) frames, and its operation is shown in FIG. 2. The original purpose of this transaction was to prevent stations in the vicinity of the receiver that cannot hear the transmitter from beginning their own transmissions. In the example shown, STA4 cannot hear transmissions from STA1. However, it hears the transmission of the CTS from STA2 and is therefore silent for the remaining duration of STA1's transmission.

A further benefit of the RTS-CTS procedure according to the invention is that it provides a fast way to establish whether or not a collision has occurred, i.e., a station within range of STA2 began transmitting simultaneously with STA1, and thereby allows recovery before a large amount of time is wasted in attempting to transmit the data payload.

For the purposes of interoperability, the RTS and CTS frames are sent in a format that legacy stations are able to receive and interpret. The DATA and ACK frames may then be sent using any modulation technique or format, with one minor point: it is necessary that the start of the DATA transmission be in a format recognisable to legacy devices, otherwise stations which hear only the RTS will reset their NAV when they hear no valid DATA transmission. However, the payload may be sent using any modulation technique.

Other frame exchanges are also possible according to the invention; for instance in a WLAN cell where the access point actively polls associated stations, the poll frame may take the place of the RTS frame in the exchange.

An alternative mechanism for interoperability according to the invention is for the transmitter to send only a CTS frame, thereby setting the NAV of all stations within range. This involves only half of the overhead of the RTS-CTS exchange, but has the drawback that stations in range of the receiver, but out of range of the transmitter, will not have their NAV set, and so offers no protection against collisions.

The overhead from the above requirements presents challenges in obtaining useful performance improvements in a MIMO WLAN. Firstly, the requirement to obtain a reliable channel estimate from each transmitting antenna to each receiving antenna requires a considerable amount of training information to be sent, and the channel estimates so generated must then be sent back to the sending station. The required time for this process scales linearly with the number of antennae if no correlation between antennae is assumed. Secondly, some form of protection frames may need to precede the main transmission to avoid conflict with legacy stations. Even if legacy stations can detect the MIMO transmission, it is still likely to be desirable to perform an RTS-CTS sequence. For efficiency, the MIMO transmissions will contain a lot of data and hence the impact of lost transmissions due to collisions will be high.

It should be noted that the present invention also relates to a transceiver functioning as a node in a communications network. An inventive transceiver comprises a first optimising unit belonging to the PHY-layer of the transceiver, which enables the transceiver to act as an inventive sending unit, and a second optimising unit belonging to the PHY-layer of the transceiver, which enables the transceiver to act as an inventive receiving unit.

In one embodiment of the present invention, a significant reduction in overhead/improvement in efficiency for OFDM-based MIMO WLAN systems that need to be backward compatible with legacy 802.11a/g systems is provided. By integrating some or all of the channel estimation and feedback steps into the RTS-CTS or POLL-CTS procedure, and optionally also other protocol information such as antenna pattern and rate selection, the desirable properties of protection from legacy device transmission and collision detection are integrated into the channel estimation procedure with very little overhead.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

A method, a communications network and a transceiver according to the present invention will now be described in more detail with reference to accompanying drawings, in which:

FIG. 1 is a schematic view of a MIMO system showing channel transfer functions between antennae;

FIG. 2 is a schematic view of the use of setting the NAV using RTS and CTS frames;

FIG. 3 is a schematic view of a sending and receiving unit and their respective PHY and MAC layers;

FIG. 4 is a schematic view of a known IEEE 802.11a/g OFDM frame structure and SIFS timing;

FIG. 5 is a schematic view of how MIMO channel estimation/feedback is integrating into the RTS-CTS exchange according to the present invention; and

FIG. 6 is a schematic view of how the exchange is extended with an additional CTS at the sending unit; and

FIG. 7 is a schematic view of computer program product and a computer readable medium according to the present invention.

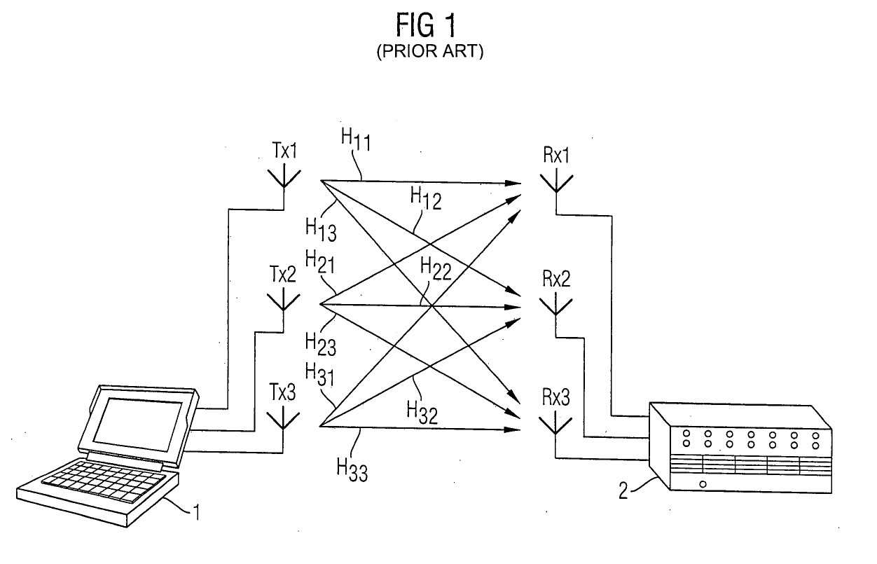

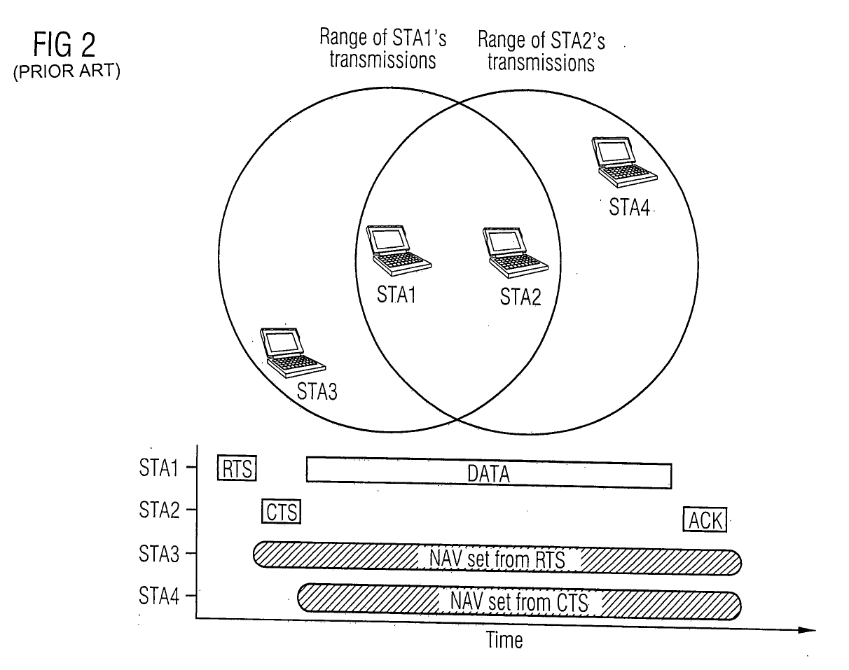

### DETAILED DESCRIPTION OF THE INVENTION

In one embodiment of the invention a MAC-layer of the sending unit is configured to form an initiating packet, and the PHY-layer of the sending unit is configured to send the initiating packet. The PHY-layer of the receiving unit is configured to receive and decode the initiating packet, and the MAC-layer of the receiving unit is configured to perform an evaluation of the initiating packet.

The MAC-layer of the receiving unit then forms a responding packet, and the PHY-layer of the receiving unit is configured to send the responding packet. The PHY-layer of the sending unit receives and decodes the responding packet, and the MAC-layer of the sending unit then evaluates the responding packet.

The present invention relates more specifically to OFDM-based wireless LAN MIMO networks, where it is desired to establish a reliable estimate of the channel transfer function from each transmitting antenna to each receiving antenna at both the receiving and transmitting devices; while maintaining interoperability with existing 802.11a/g OFDM devices.

For purposes of the present invention, the OSI, or Open System Interconnection, model defines a networking framework for implementing protocols in seven layers. Control is passed from one layer to the next, starting at the application layer in one station, proceeding to the bottom layer, over the channel to the next station and back up the hierarchy.

The Physical (PHY) layer is the first layer or bottom layer of the OSI model. It conveys the bit stream, electrical impulse, light or radio signal, through the network at the electrical and mechanical level. It provides the hardware means of sending and receiving data on a carrier, including defining cables, cards and physical aspects.

The Media Access Control (MAC) Layer is one of two sublayers that make up the second layer, the Data Link Layer, of the OSI model. The MAC layer is responsible for moving data packets to and from one Network Interface Card to another across a shared channel. The MAC-layer also controls how a computer on the network gains access to the data and permission to transmit it.

The other sublayer of the Data Link Layer is the Logical Link Control layer, that controls frame synchronization, flow control and error checking.

Orthogonal Frequency Division Multiplexing (OFDM) is an FDM modulation technique for transmitting large amounts of digital data over a radio wave. OFDM works by splitting the radio signal into multiple smaller sub-signals that are then transmitted concurrently at different frequencies to the receiver.

Multiple-input multiple-output (MIMO) networks are networks where the sender and receiver both use multiple antennae for both transmission and reception.

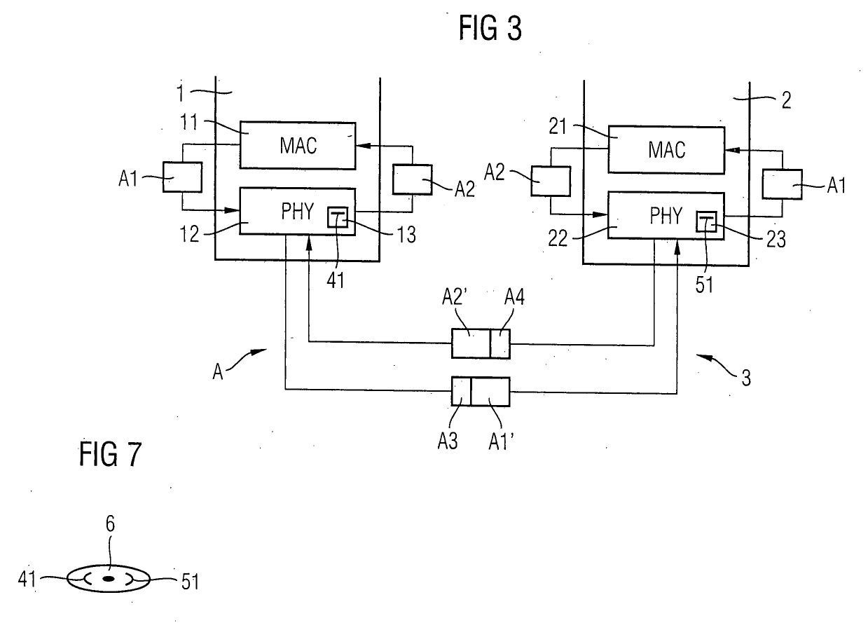

With reference to FIG. 3, a method of setting up a communications channel A between a sending unit 1 and a receiving unit 2 in a packet based communications network 3 is illustrated.

The MAC-layer 11 of the sending unit 1 is configured and employed to form an initiating packet Al and the PHY-layer 12 of the sending unit 1 is configured and employed to send or transmit the initiating packet A1′ to the receiving unit 2.

The PHY-layer 22 of the receiving unit 2 is configured and employed to receive and decode the initiating packet A1′ and the MAC-layer 21 of the receiving unit 2 is configured and employed to perform an evaluation of the initiating packet A1 and to form a responding packet A2.

The PHY-layer 22 of the receiving unit 2 is configured and employed to send the responding packet A2′, and the PHY-layer 12 of the sending unit 1 is brought to receive and decode the responding packet A2′ and the MAC-layer 11 of the sending unit 1 is configured and employed to evaluate the responding packet A2.

According to one embodiment of the present invention a first optimising unit 13, associated with the PHY-layer 12 of the sending unit 1 appends communication parameters A3 pertaining to the sending unit 1 to the initiating packet A1′ which are sent during some of the time period used for the decoding by the PHY layer 22 or evaluation by the MAC-layer 21 of the receiving unit 2.

A second optimising unit 23 associated with the PHY-layer 22 of the receiving unit 2 analyses the communication parameters A3 of the sending unit 1 and appends communication parameters A4 pertaining to the receiving unit 2 to the responding packet A2′ which are sent during some of the time period used for the decoding by the PHY layer 22 or evaluation by the MAC-layer 21 of the sending unit 1.

The first optimising unit 13 analyses the communication parameters A4 of the receiving unit 2 and optimises the set-up of the PHY-layer 12 of the sending unit 1 according to the communication parameters A4 of the receiving unit 2. Likewise, the second optimising unit 23 optimises the set-up of the PHY-layer 22 of the receiving unit 2 according to the communication parameters A3 of the sending unit 1.

According to another embodiment of the present invention, if the set-up of the communications channel A comprises the sending and receiving of several packets between the sending and receiving unit, then the first and second optimising units 1, 2 are used at any time required by the MAC-layers 11, 21 of the sending and receiving units 1, 2 to evaluate and form these packets to send communications parameters, to evaluate communication parameters and to optimise the set-up of the respective PHY-layer 12, 22.

In the above example, the unit that initiates a communications channel has been called a sending unit and the other unit has been called a receiving unit. The present invention contemplates, however, that any one unit in a communications network may act as both a sending and a receiving unit. Such a unit is often called a transceiver.

The present invention thus relates to a system and method for a transceiver to function as a node in a communications network, where a first optimising unit, belonging to the PHY-layer of the transceiver, enables the transceiver to act as an inventive sending unit. The invention also comprises a second optimising unit, belonging to the PHY-layer of the transceiver, that enables the transceiver to act as an inventive receiving unit. The present invention may be used in any packet based communications network. The invention will now be described in more detail through the description of an embodiment where the communications network and the sending and receiving units 1, 2 acting within the network are brought to transmit and receive packets compatible with the IEEE 802.11a or 802.11g WLAN standard.

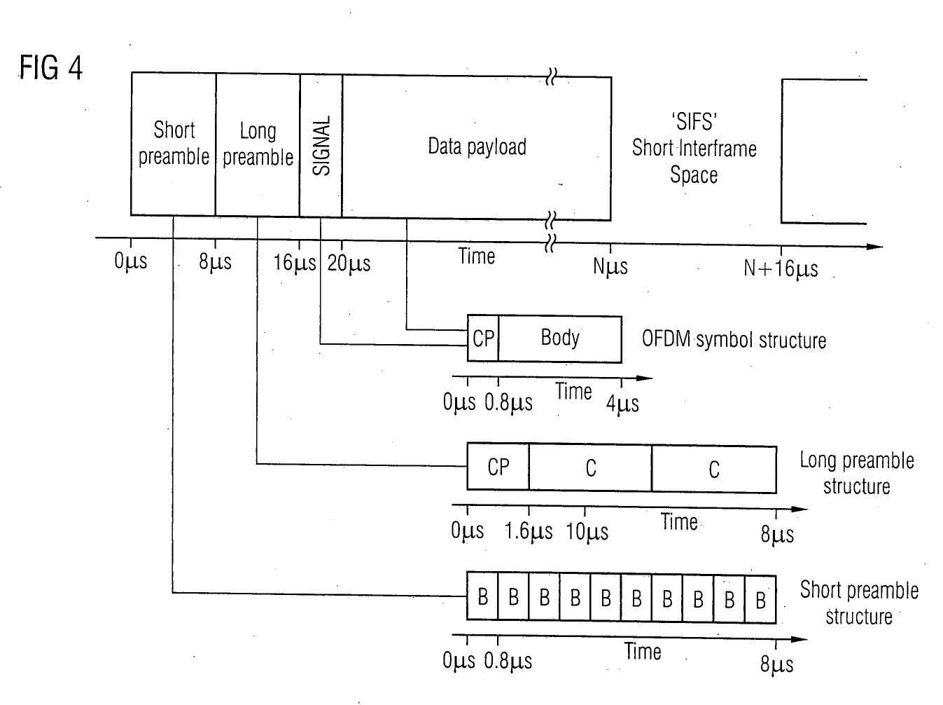

The structure of a legacy 802.11a/g OFDM transmission, as well as the timing requirements of the RTS-CTS/POLL-CTS exchange, will now be described with reference to FIG. 4 in order to facilitate the understanding of the present invention.

An initiating packet A1 begins with the so-called short preamble. This consists of 10 repeats of a 0.8 μs sequence. This section is used by the receiving unit to detect the arrival of an incoming transmission and to perform some first coarse estimates of e.g. frequency offset. The next phase of the initiating packet A1 is the long preamble, which is generally used to perform fine estimation of the frequency offset and is also used to estimate the channel transfer function for each subcarrier. The long preamble comprises 2 copies of a 3.2 μs long symbol, preceded by a 1.6 μs cyclic prefix: the cyclic prefix is a copy of the last half of a symbol, and means that multipath dispersion up to 1.6 μs in duration will have no effect on the channel estimate. After the long preamble comes the SIGNAL field: this is the first information-carrying symbol in the initiating packet, and is sent using the most robust form of BPSK coding. This symbol encodes information about the length and data rate of the remainder of the transmission. From this point onward the remainder of the transmission consists of OFDM data symbols modulated according to the parameters sent in the SIGNAL field. All information carrying symbols (the SIGNAL field and subsequent data payload) use the same OFDM symbol structure.

At the end of a transmitted frame, the standard defines that there is a pause of a fixed length before the recipient must reply. This pause is known as the “short interframe space” (SIFS). This is designed to be the absolute minimum amount of time that a low-complexity receiver implementation would need to decode the received message, determine whether it is required to reply, and to switch over from reception to transmission mode.

802.11a/g OFDM transmissions use convolutional coding of the transmitted signal, requiring a Viterbi decoder in the receiver. A large portion of this SIFS time is therefore dedicated to the latency of the Viterbi decoder. As an indication of its magnitude, the 802.11b standard requires no Viterbi decoder, and SIFS time is defined as 9 μs as compared to 16 μs for 802.11a. The time require to switch from receive to transmit is, on the other hand, small (required to be <2 μs).

The present invention makes use of this “dead time” at the end of an OFDM frame transmission in order to allow MIMO transceivers to transmit extra information to enable channel estimation and the transmission of the resulting channel estimates. The OFDM frame is transmitted as per the 802.11a/g standard, possibly with the exception that one of the bits in the PLCP header that are denoted “Reserved” in the current standard may be used to indicate to MIMO transceivers that this frame contains extra information. Thus, legacy 802.11a/g devices will receive the frame as normal and interpret the data contained therein. However, at the end of the OFDM frame additional information is appended. This is ignored by legacy devices, but may be used by MIMO transceivers.

In one embodiment of the invention this technique is used in conjunction with the RTS-CTS (or POLL-CTS) frame exchange. Since MIMO transmissions will involve large amounts of data in order to minimise the impact of overheads, it is highly likely that RTS-CTS will be needed anyway, so as to provide medium reservation/collision detection. The transmitted sequence could then be as shown in FIG. 5, where data not interpreted by legacy devices is shown as hatched portions.

Firstly, the transmitting MIMO-enabled device sends an RTS (or POLL) frame. This causes legacy devices within range of the transmitter to set their NAV such that the remainder of the transmission is protected (including the MIMO sections which they may not be able to decode or detect). If one of the reserved bits in the transmission are used, these will be ignored by legacy devices. At the end of the RTS/POLL frame, legacy devices cease reception. However, MIMO-enabled devices will continue receiving the extra training sequence at the end of the frame. This could, for instance, be a long preamble sequence transmitted using a different set of antennae, or a different subcarrier to antenna mapping, to that used for the preceding sections of the frame. It should be noted that the timing requirements for decoding the RTS or POLL information for the MIMO-enabled device are not affected, since this information can be processed within the receiving device's Viterbi decoder and subsequently in the MAC layer at the same time as the extra training sequence is being received.

An additional refinement according to one embodiment of the invention is to actually encode protocol information in the extra training sequence; e.g., information on the number of transmitting antennae and the transmission rate to be used. If this is encoded in the most robust BPSK transmission mode, the channel estimates available from the previous estimation could be extrapolated to give a sufficient estimate quality to demodulate the information and thereby determine the transmitted data sequence. At this point channel estimation can proceed in the conventional manner.

After receiving the RTS/POLL frame, the receiving MIMO-enabled device will have observed that a MIMO transmission is being established, and responds to the RTS frame with a CTS frame. This causes legacy devices within range of the receiver to set their NAV to protect the remainder of the transmission. At the end of the CTS frame, additional OFDM symbols are appended in which the channel estimate made at the receiving MIMO-enabled device is encoded. A 54 Mbps OFDM symbol can encode 216 data bits, and so two such symbols can encode 432 data bits. These additional symbols are ignored by legacy devices.

Assuming the amount of channel estimate information that could be transferred at the end of the CTS frame is sufficient, the transmitting MIMO-enabled device can proceed with the main transmission.

For the case where RTS-CTS was used to reserve the medium, the legacy standard states that devices that hear an RTS frame but do not observe the start of a subsequent data frame may reset their NAV. In order to avoid this, FIG. 5 depicts the main transmission beginning with a full OFDM preamble and SIGNAL field. This overhead could be eliminated if protection in the vicinity of the receiver was considered adequate.

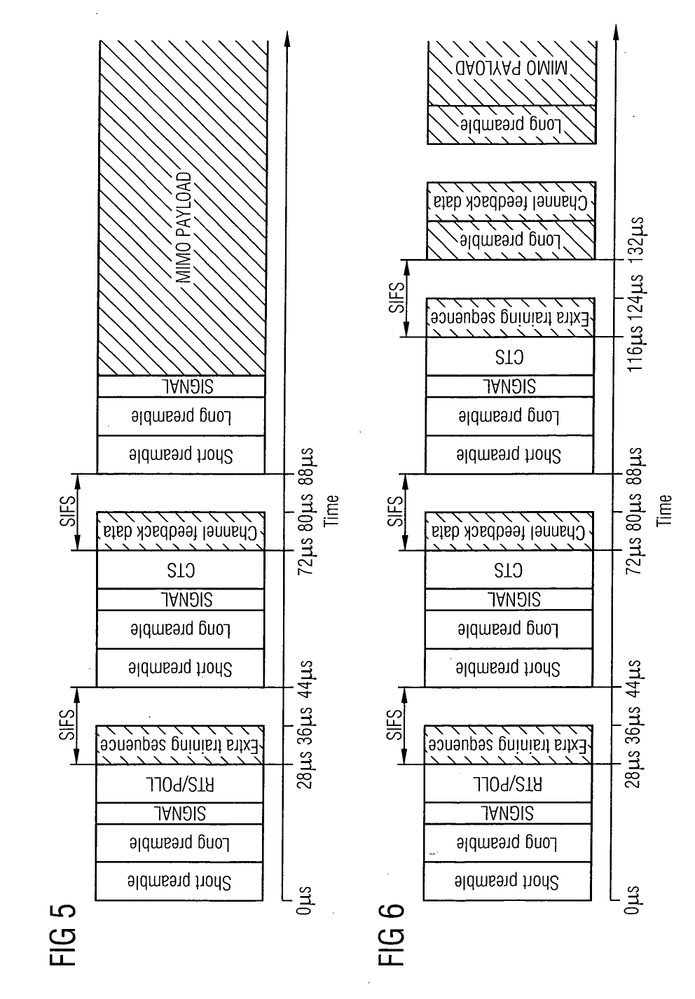

In the case that a greater amount of channel estimate information needs to be transferred (e.g., in the case of a large number of transmit antennae being used), the technique can be extended as shown in FIG. 6. An additional CTS frame is sent by the transmitting MIMO-enabled device, with an additional training sequence appended which allows further channel estimation to be performed at the MIMO-enabled receiver. Legacy receivers will observe only an additional CTS frame, which will cause all devices within range of the transmitting MIMO-enabled device to set their NAV for the remaining duration of the transmission.

After this stage, there is no requirement to maintain compatibility with 802.11a/g frame formats since all legacy devices within range of both the transmitter and the receiver have their NAV set. FIG. 6 shows one possible example where the remaining channel estimate information is sent back from the receiving device to the transmitting device preceded only by a long preamble, in this case to enable timing and phase resynchronisation. After this, the transmitting device can proceed with the main MIMO transmission, which is similarly preceded by a long preamble sequence.

The present invention also relates to a first computer program product 4, comprising computer program code 41, schematically shown in FIG. 3, which, when executed by a computer unit, enables this computer unit to act as an inventive first optimising unit 13.

The present invention also relates to a second computer program product 5, comprising computer program code 51, schematically shown in FIG. 3, which, when executed by a computer unit, enables this computer unit to act as an inventive second optimising unit 23.

FIG. 7 shows that the present invention also relates to a computer readable medium 6, in the figure exemplified by a compact disc, on which the storage of computer program code 41, 51 according to the first or second computer program product is stored.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method of setting up a communications channel between a sending unit and a receiving unit in a packet based communications network, comprising:
forming an initiating packet via a MAC-layer of the sending unit;
appending communication parameters to the initiating packet via a first optimising unit of a PHY-layer of the sending unit, thereby forming an appended initiating packet;
sending the appended initiating packet via the PHY-layer of the sending unit over a communications medium to the receiving unit;
receiving and decoding the appended initiating packet via a PHY-layer of the receiving unit;
optimizing a set-up of the PHY-layer of the receiving unit via a second optimising unit associated with the PHY-layer of the receiving unit based on the communication parameters in the appended initiating packet;
performing an evaluation of the decoded appended initiating packet via a MAC-layer of the receiving unit;
forming a responding packet via the PHY-layer of the receiving unit;
appending communication parameters to the responding packet via the second optimising unit of the PHY-layer of the sending unit, thereby forming an appended responding packet;
sending the appended responding packet via the PHY-layer of the receiving unit over the communication medium to the sending unit;
receiving and decoding the appended responding packet via the PHY-layer of the sending unit;
evaluating the appended responding packet via the MAC-layer of the sending unit;
optimizing a set-up of the PHY-layer of the sending unit via the first optimising unit based on the communication parameters in the appended responding packet;
wherein the appended communication parameters associated with the sending unit are transmitted over the communication medium from the sending unit to the receiving unit at a time period in which an initiation information portion of the appended initiation packet is being decoded by the PHY-layer of the receiving unit or evaluated by the MAC-layer portion of the receiving unit, and
wherein the appended communication parameters associated with receiving unit are transmitted over the communication medium from the receiving unit to the sending unit at a time period in which a responding information portion of the appended responding packet is being decoded by the PHY-layer of the sending unit or evaluated by the MAC-layer portion of the sending unit.

2. The method of claim 1, wherein the sending and receiving units are configured to transmit packets compatible with the IEEE 802.11a or 802.11g WLAN standard.

3. The method of claim 2, wherein the initiating packet comprises a RTS or Poll message, and the responding packet comprises a CTS message.

4. The method of claim 3, wherein the analysing of the received communication parameters performed by the first and second optimising units is done at least during a SIFS between said RTS, Poll, or CTS, and a following communication packet.

5. The method of claim 1, wherein the sending and receiving units comprise MIMO transceivers, and wherein the added communication parameters pertaining to the sending unit comprises an extra training sequence operable to enable channel estimation, and wherein the added communication parameters pertaining to the receiving unit comprise channel feedback data.

6. The method of claim 5, wherein the extra training sequence comprises protocol information including a number of transmitting antennae and the transmitting rate to be used.

7. The method of claim 5, wherein the channel feedback information comprises channel estimates made by the second optimising unit including an optimised channel transfer function.

8. The method of claim 3, further comprising:
using a reserved bit in the RTS or Poll message to indicate a use of communication parameters to units within a communication network containing first or second optimisation units, and
ignoring the bit by legacy units in the network not having the first or second optimisation units.

9. A packet based communications network, comprising:
at least a sending unit and a receiving unit each comprising a PHY-layer and a MAC-layer, respectively, wherein the MAC-layer of the sending unit is adapted to form an initiating packet and the PHY-layer of the sending unit is adapted to send the initiating packet over a communication medium, wherein the PHY-layer of the receiving unit is adapted to receive and decode the initiating packet and the MAC-layer of the receiving unit is adapted to perform an evaluation of the initiating packet and to form a responding packet, wherein the PHY-layer of the receiving unit is adapted to send the responding packet over the communication medium, and wherein the PHY-layer of the sending unit is adapted to receive and decode the responding packet and the MAC-layer of the sending unit is adapted to evaluate the responding packet;
wherein the PHY-layer of the sending unit further comprises a first optimising unit and the PHY-layer of the receiving unit further comprises a second optimising unit,
wherein the first optimising unit is adapted to append communication parameters pertaining to the sending unit to the initiating packet, and wherein the communication parameters are sent from the sending unit to the receiving unit during a time period used for the decoding of an initiating information portion of the initiation packet by the PHY layer of the receiving unit or the evaluation thereof by the MAC-layer of the receiving unit, and
wherein the second optimising unit is adapted to analyse the communication parameters of the sending unit and append communication parameters pertaining to the receiving unit to the responding packet, and wherein the communication parameters are sent during a time period used for the decoding of a responding information portion of the responding packet by the PHY layer of the sending unit or the evaluation thereof by the MAC-layer of the sending unit.

10. The network of claim 9, wherein the first optimising unit is further adapted to analyse the communication parameters of the receiving unit and optimise a set-up of the PHY-layer of the sending unit according to the communication parameters of the receiving unit, and wherein the second optimising unit is adapted to optimise a set-up of the PHY-layer of the receiving unit according to the communication parameters of the sending unit.

11. The network of claim 9, wherein the sending and receiving units are adapted to transmit packets compatible with the IEEE 802.11a or 802.11g WLAN standard.

12. The network of claim 11, wherein the initiating packet comprises a RTS or Poll message, and wherein the responding packet comprises a CTS message.

13. The network of claim 12, wherein the first and second optimising units are adapted to perform the analysing of the received communication parameters at least during a SIFS between the RTS, Poll, or CTS, and a following communication packet.

14. The network of claim 9, wherein the sending and receiving units are MIMO transceivers, and wherein the added communication parameters pertaining to the sending unit comprises an extra training sequence to enable channel estimation, and wherein the added communication parameters pertaining to the receiving unit comprises channel feedback data.

15. The network of claim 14, wherein the extra training sequence comprises protocol information including information on a number of transmitting antennae and a transmitting rate to be used.

16. The network of claim 14, wherein the channel feedback information comprises channel estimates made by the second optimising unit including an optimised channel transfer function.

17. The network of claims 11, further comprising a reserved bit in the RTS or Poll message configured to indicate a use of communication parameters by a first or second optimisation unit in the sending or receiving units within the network, wherein the bit is ignored by legacy units in the network not having a first or second optimisation unit.
